(19) United States
(12) Patent Application Publication
(10) Pub. No.: US 2009/0000507 A1
(43) Pub. Date: Jan. 1, 2009

(54) Carrier Liquid for Agent Concentrates and Use Thereof

(76) Inventors: Horst Ring, Boeblingen (DE); Martin Husmann, Boeblingen (DE); Juergen Weigel, Grentach-Wyhlen (DE)

Correspondence Address: HAYES SOLOWAY P.C., 130 W. Cushing Street, Tucson, AZ, 85701, US

(21) Appl. No.: 11/572,992

(22) PCT Filed: Aug. 9, 2005
(86) PCT No.: PCT/EP05/08657

§ 371 Date: Jan. 30, 2007

(30) Foreign Application Priority Data
Aug. 12, 2004 (DE) 10 2004 039 183.1

(51) Int. Cl. C09D 5/14

(52) U.S. Cl. 106/15.05; 106/311

(57) ABSTRACT

A carrier liquid for agent concentrates which are added to polymerizates that are suitable for melt spinning is proposed, the carrier liquid comprising three components, namely a) a base oil as main constituent having a thermostability of more than 300° C.; b) at least one antioxidant acting as a radical trap; and c) at least one compound which deactivates catalysts for the polymerization of fiber-forming materials that are suitable for melt spinning. The carrier liquid is used for the production of an agent concentrate which contains color pigments, bactericides and/or fungicides for polymerizates that are suitable for melt spinning. The agent concentrates are used for spin dyeing textile fibers and technical fibers, particularly partially oriented yarns.

The invention relates to a carrier liquid for agent concentrates and the use thereof, particularly for those agent concentrates that are added to polymerizates which are suitable for melt spinning in order to produce textile fibers, technical fibers or injection-molded parts therefrom, in which the agent or the agents from the concentrate is/are evenly spread over the entire polymer mass.

It is known to dye polyester and polyamide fibers by bath dyeing (high-temperature method, thermosol method, reactive dyeing) or by spin dyeing (beater dyeing), i.e. to incorporate an agent, for example in the form of a color pigment into the fibers.

The principle of the bath dyeing consists in that the dye is allowed to penetrate more or less into the fiber. Under suitable conditions (duration of the treatment, temperature), the fiber is permeated by the dye or by any agent, for example a fungicide. Here, there is no limitation for the selection of the hues. However, unlike in textile fibers, in technical fibers the fastnesses obtained up to now are generally not sufficient.

This is the reason why in the case of technical fibers the beater dyeing is preferred in which master batches on the basis of the polymerizate whereof the fiber is made are used as dye concentrates. However, due to the high thermal stress during the production and the use of the master batches, only thermostable dye may be used. The esthetic effects, namely the brilliance and the luminosity, as can be obtained in the bath dyeing, leave much to be desired in the beater dyeing. For this reason it would be welcome to have the possibility to use at least the same dye range in the beater dyeing as in the bath dyeing.

In the production of bottles and other hollow bodies of polyester, it is already known to add liquid concentrates containing the dyes to the polymer material. Liquid concentrates offer the advantage that a broad range of dyes may be used and that the dyeing process is substantially simplified.

But the dye concentrates used in the bottle production do not meet the requirements that have to be fulfilled in the production of polymer fibers. For example, the dye quantities have to be ten times as high as in the bottle production with regard to the color depth to be obtained. The quantity of carrier liquid which is introduced in the polymer with the dye concentrates also increases at least to the same degree.

When using the carrier liquids known so far, a degradation, i.e. a breakdown of the polymer and thus an impairment of the mechanical properties of the polymerizate however occurs, which in turn would lead to disturbances in the spinning process and in the further processing during the production of fibers.

This is why the object of the invention is to provide a carrier liquid for agent concentrates which may be added to polymerizates which are suitable for melt spinning and from which textile fibers, technical fibers or injection-molded parts can be produced, without the risk of a polymer degradation. The carrier liquid should furthermore be able to introduce high agent concentrations into the polymer in order to keep the required carrier liquid quantity as low as possible and thus to counteract a dilution of the polymer melt that is to be processed in the melt spinning method.

According to the invention, this object is achieved by the carrier liquid having the features of claim 1.

Advantageous further developments of the carrier liquid according to the invention additionally comprise the features of at least one of claims 2 to 13.

The carrier liquid according to the invention is preferably used for the production of an agent concentrate containing color pigments, bactericides and/or fungicides for polymerizates that are suitable for melt spinning. The use of the carrier liquid according to the invention is however not limited thereto. Basically, any agent, for example a flameproofing agent, too, may be transported in the polymerizate and thus finally in the fibers by means of the carrier liquid as long as it is compatible with the carrier liquid and the polymerizate to be finished.

The agent concentrate containing the carrier liquid according to the invention is advantageously used for spin dyeing textile fibers and technical fibers, particularly for spin dyeing partially oriented yarns (POY-yarns). The carrier liquid according to the invention comprises three components, namely
a) a base oil as main constituent having a boiling point of more than 300° C. at normal pressure;
b) at least one antioxidant acting as radical trap; and
c) at least one compound which deactivates catalysts for the polymerization of fiber-forming materials that are suitable for melt spinning.

A thermostable ester oil, particularly preferably TMP-trioleate, is preferably used as base oil.

Other preferred base oils are mineral oils, aliphatic hydrocarbons such as for example paraffinic white oil, alkylated aromatic hydrocarbons such as for example a C18 to C30 alkyl benzene derivative.

Preferably, the base oil has a viscosity (at room temperature) of less than 500 mPas.

Antioxidants which are suitable for the purposes according to the invention and act as radical trap are those that are based on phosphites or sterically hindered phenols, for example trisnonylphenylphosphite and 4,4-butylidene-bis-(6-tert-butyl-m-cresol). The radical traps reduce the thermal decomposition of the polymers as well as that of the liquid. The thermal decomposition of the liquid which may lead to the degradation of the polymerizate is avoided by a suitable choice of the antioxidants.

According to the invention, isopropylated triarylphosphates and diphenyl-(2-ethylhexyl)phosphate are preferably used as catalyst deactivators. These deactivators block the residual quantities of polymerization catalysts in the polymerizate, for example Sb(III)-catalysts and Ti-catalysts. But color pigments which may operate as catalysts are also blocked by these deactivators.

The radical traps and the catalyst deactivators together also lead to synergistic effects and decelerate for example the polymer degradation processes favored by residual quantities of catalysts.

The carrier liquid according to the invention has particularly the advantage that the physicochemical properties of the polymerizates that are suitable for melt spinning are maintained to the extent that the resulting polymer melt remains spinnable, more specifically even if larger quantities of carrier liquid (up to 10 wt %) have to be incorporated in a polymer matrix, for example made of PET.

In comparison with the known bath method initially described, the liquid concentrate method is substantially ecologically more compatible since no waste water is produced. With the new method it is further possible to respond to market or fashion requirements in a more flexible way since the quantities of transition waste which arise during a color change are much smaller than in the use of solid master batches. As a result, it is also possible to realize smaller production quantities of polymer fibers economically. Furthermore, an extended hue range with esthetic effects that are more attractive is available.

A preferred embodiment of the carrier liquid according to the invention consists of 94.2 wt % TMP-trioleate, 0.4 wt % trisnonylphenylphosphite, 0.4 wt % 4,4-butylidene-bis-(6-tert-butyl-m-cresol) and 5 wt % isopropylated triarylphosphates, and is water-free.

For testing purposes, this carrier liquid according to the invention was mixed with PET in a special melting device at 300° C. under nitrogen by continuous stirring for 15 minutes (which approximately corresponds to the residence time of the polymer melt from the extruder to the spinneret). The polymer samples were then rapidly cooled and their relative viscosities were determined. The relative or intrinsic viscosity is a measure for the mean molecular mass of the polymer.

Pure glycerol trioleate which is used as carrier liquid for dye concentrates for the dyeing of PET bottles served as reference substance. In comparison with the spin dyeing, the bottle dyeing however requires only approximately a tenth of the pigment quantities for the dyeing, and so a correspondingly low amount of carrier liquid is required. Studies have shown that the use of the reference substance in the high concentration range, as is required for the spin dyeing, leads to a strong polymer degradation. The strength of the partially oriented yarns that are produced in this way is insufficient and not suitable for a subsequent texture.

In comparison therewith, the polymerizate samples which contain approximately 5 wt % of the carrier liquid of the present invention have a higher relative viscosity or a less strong polymer degradation. Due to the combination of the TMP-trioleate with radical traps and catalyst deactivators it was possible to obtain a further increase of the relative viscosity and thus a great approximation to the ideal value of the blind sample (dried PET).

Even after the addition of different dye dispersions to the polymer samples with the carrier liquid according to the invention and to polymer samples with the reference substance, i.e. glycerol trioleate, it appeared that the relative viscosity was principally reduced in all cases since the pigments support a polymer degradation, but in comparison with the reference tests, the degradation is less pronounced when the carrier liquid according to the invention is used. In the subsequent spin and texture tests it was possible to produce partially oriented yarns which could be textured without any problems. The strength and the extension as well as the surging limits met all requirements made to filaments of polyethylene terephthalate, which is not possible with the reference substance, i.e. glycerol trioleate.

1. A carrier liquid for agent concentrates which are added to polymerizates that are suitable for melt spinning, comprising three components, namely
a) a base oil as main constituent having a boiling point of more than 300° C. at normal pressure;
b) at least one antioxidant acting as a radical trap; and
c) at least one compound which deactivates catalysts for the polymerization of fiber-forming materials that are suitable for melt spinning.

2. The carrier liquid according to claim 1, wherein the base oil is a thermostable ester oil.

3. The carrier liquid according to claim 2, wherein the ester oil is TMP-trioleate.

4. The carrier liquid according to claim 1, wherein the base oil consists substantially of aliphatic hydrocarbons.

5. The carrier liquid according to claim 4, wherein the base oil is a paraffinic white oil.

6. The carrier liquid according to claim 1, wherein the base oil consists substantially of alkylated aromatic hydrocarbons.

7. The carrier liquid according to claim 6, wherein the base oil is alkyl benzene.

8. The carrier liquid according to claim 1, wherein the base oil has a viscosity of less than 500 mPas at room temperature.

9. The carrier liquid according to claim 1 wherein the at least one antioxidant is an antioxidant on the basis of phosphites or sterically hindered phenols.

10. The carrier liquid according to claim 9, wherein said antioxidant comprises at least one of trisnonylphenylphosphite and 4,4-butylidene-bis-(6-tert-butyl-m-cresol).

11. The carrier liquid according to claim 1, wherein said compound which deactivates catalysts comprises at least one phosphate as catalyst deactivator.

12. The carrier liquid according to claim 11, wherein said phosphate comprises at least one of an isopropylated triarylphosphate and diphenyl-(2-ethylhexyl)phosphate.

13. The carrier liquid according to claim 1, wherein the base oil accounts for at least 90 wt % of the liquid.

14. The carrier liquid according to claim 1, wherein the catalyst deactivator accounts for at most 9 wt % of the liquid.

15-17. (canceled)

18. An agent concentrate comprising
a) a base oil as main constituent having a boiling point of more than 300° C. at normal pressure;
b) at least one antioxidant acting as a radical trap;
c) at least one compound which deactivates catalysts for the polymerization of fiber-forming materials that are suitable for melt spinning;
d) color pigments; and
e) at least one of bactericides and fungicides.

19. The agent concentrate of claim 18 when used for spin dyeing of at least one of textile fibers, technical fibers, and partially oriented yarns.
